(19) United States
(12) Patent Application Publication
(10) Pub. No.: US 2023/0276753 A1
(43) Pub. Date: Sep. 7, 2023

(54) DRIP IRRIGATOR FOR FILM-MULCHING DRIP IRRIGATION, FILM-MULCHING IRRIGATION ASSEMBLYAND INSTALLATION METHOD OF FILM MULCHING IRRIGATION ASSEMBLY

(71) Applicant: Farmland Irrigation Research Institute, Chinese Academy of Agricultural Sciences, Xinxiang (CN)

(72) Inventors: Peng LI, Xinxiang (CN); Yongshen FAN, Xinxiang (CN); Fuyi DUAN, Xinxiang (CN); Yinbo CAO, Xinxiang (CN); Chunya MA, Xinxiang (CN); Hua CAO, Xinxiang (CN); Jianzheng HAN, Xinxiang (CN)

(21) Appl. No.: 17/734,084

(22) Filed: May 1, 2022

(30) Foreign Application Priority Data
Mar. 2, 2022 (CN) 202210196527.0

(51) Int. Cl. A01G 25/06

(52) U.S. Cl. CPC A01G 25/06

(57) ABSTRACT

A drip irrigator for film-mulching drip irrigation, a film-mulching irrigation assembly and an installation method of the film-mulching irrigation assembly are provided. The drip irrigator includes a main pipeline, branch pipes and emitters. Emitter are arranged on an upper surface of the branch pipe and communicate with the branch pipe, water outlet holes are formed in inner and outer ring walls of an annular pipeline, and an opening end of the main pipeline communicates with a water conveying pipeline. By arranging emitters on the upper surface of each branch pipe, the emitters can be effectively prevented from being blocked by wet soil. Meanwhile, the water outlet holes can perform the drip irrigation to the ground simultaneously, and the overall efficiency of drip irrigation to the soil is guaranteed.

### TECHNICAL FIELD

The present disclosure relates to the field of water-saving irrigation technologies, in particular to a drip irrigator for film-mulching drip irrigation, a film-mulching irrigation assembly and an installation method of the film-mulching irrigation assembly.

### BACKGROUND ART

The micro-spray irrigation technology is an advanced irrigation technology for effectively adjusting moisture in crops, and has the characteristics of water saving, energy saving, uniform irrigation, high irrigation quality and the like by adopting pipeline water-delivery. Further, combined with foliar fertilization and pesticide spraying on the crops, the micro-spray irrigation technology is high in atomization degree during the spraying process. In this way, the humidity of surfaces of the crops and the humidity of air are increased, the field microclimate is adjusted, the disease and insect pest is reduced, and both the quality and the yield of the crops are improved.

The existing micro-irrigation technology includes drip irrigation pipes, a drip irrigation pipe group and a micro-spraying pipe group. The drip irrigation pipes, the drip irrigation pipe group and the micro-spraying pipe group are prone to aging after frequently being irradiated under sunlight. Further, this micro-irrigation technology causes the rapid reduction of the humidity of soil after irrigation is finished, and thus crop moisture conservation is not facilitated. In addition, the existing drip irrigator inserted in soil is prone to being blocked, so that the efficiency of the drip irrigation is low and even the drip irrigation cannot be carried out continuously. For example, an emitter for drip irrigation and a drip irrigation device disclosed by the patent publication No. CN104684381B as well as an emitter for drip irrigation and a drip irrigation device with the emitter for drip irrigation disclosed by the patent application publication No. CN104853592A all have the problems that water loss in soil is too fast and the emitters are prone to being blocked.

In order to solve the problems, the present disclosure provides a drip irrigator for film-mulching drip irrigation, a film-mulching irrigation assembly and an installation method of the film-mulching irrigation assembly, which aims to solve the problems that water loss in soil is too fast and emitters are easily blocked.

### SUMMARY

The present disclosure aims to provide a drip irrigator for film-mulching drip irrigation, a film-mulching irrigation assembly and an installation method of the film-mulching irrigation assembly, so as to achieve the purposes that water loss in soil is slowed down and emitters are prevented from being easily blocked.

In order to achieve the purposes, the present disclosure provides the following scheme.

A drip irrigator for film-mulching drip irrigation includes a main pipeline, as well as an annular pipeline and a plurality of branch pipes sequentially arranged on the main pipeline from top to bottom and communicate with the main pipeline. An end of the main pipeline is closed end and an other end of the main pipeline is an opening end. Each of the branch pipes is provided with a plurality of emitters, the emitters are arranged on an upper surface of the branch pipe and communicate with the branch pipe. Water outlet holes are formed in an inner ring wall and an outer ring wall of the annular pipeline, and the opening end of the main pipeline communicates with a water conveying pipeline.

In some embodiments, a plane where the annular pipeline may be located may be perpendicular to the main pipeline, and the main pipeline may be arranged in a center of the annular pipeline and may communicate with the annular pipeline through a plurality of connecting pipes.

In some embodiments, the branch pipes may be distributed on the main pipeline at equal intervals, and a distance between every adjacent two of the branch pipes may range from 4 cm to 6 cm.

In some embodiments, an included angle between each of the branch pipes and the main pipeline may range from 30 degrees to 75 degrees.

In some embodiments, the closed end of the main pipeline may be conical.

In some embodiments, the main pipeline may be made of polyethylene.

In some embodiments, a distance between every adjacent two of the emitters may be 0.2 cm to 0.5 cm, and a length of each of the branch pipes may be 2 cm to 5 cm.

A film-mulching irrigation assembly includes the drip irrigator for film-mulching drip irrigation. The film-mulching irrigation assembly includes a main through pipe, a plurality of branch through pipes and a film. Upper surfaces of the main through pipe and the branch through pipes are mulched with the film. The branch through pipes are uniformly arranged on two sides of the main through pipe respectively and communicate with the main through pipe. One end of the main through pipe communicates with a micro-irrigation head pivot, an other end of the main through pipe is closed. An end, which is away from the main through pipe, of each of the branch through pipes is closed, and the drip irrigator for film-mulching drip irrigation is arranged on a lower surface of each of the branch through pipes.

In some embodiments, the main through pipe may be perpendicular to each of the branch through pipes.

An installation method of the film-mulching irrigation assembly includes the following steps: arranging a film on upper surfaces of a main through pipe and a plurality of branch through pipes in advance, and arranging drip irrigators for film-mulching drip irrigation on a lower surface of each of the branch through pipes; laying the film, the main through pipe and the branch through pipes which are arranged together in advance on a ground, and inserting the drip irrigators for film-mulching drip irrigation under the ground; and connecting one end of the main through pipe with a micro-irrigation head pivot, and closing an other end of the main through pipe.

Compared with the prior art, the present embodiment has the following technical effects.

Firstly, the emitters are arranged on the upper surface of each branch pipe, so that the emitters can be effectively prevented from being blocked by wet soil. Meanwhile, water outlet holes formed in the inner ring wall and the outer ring wall of the annular pipeline can be used for drip irrigation to the ground simultaneously, and the overall efficiency of the drip irrigation to the soil is guaranteed. In addition, in the film-mulching irrigation assembly, the main through pipe and the branch through pipes are mulched with the film, so the evaporation loss of water is reduced, sufficient water in the soil is guaranteed, and smooth growth of plants is guaranteed.

Secondly, the plane where the annular pipeline is located is perpendicular to the main pipeline, and the main pipeline is arranged in the center of the annular pipeline and communicates with the annular pipeline through a plurality of connecting pipes. That is to say, the annular pipeline can be horizontally placed on the ground, and wet drip irrigation to the ground is completed through the water outlet holes of the annular pipeline, which guarantees that water in the annular pipeline can irrigate the soil in a manner of the largest area and the fastest speed.

Thirdly, the included angle between each branch pipe and the main pipeline ranges from 30 degrees to 75 degrees, so that downward insertion of the main pipeline and the branch pipes is facilitated, and the resistance from the soil is reduced.

Fourthly, the main pipeline is made of polyethylene, which guarantees that the main pipeline cannot deform when being inserted into the soil.

### BRIEF DESCRIPTION OF THE DRAWINGS

To describe the technical scheme in the embodiments of the present disclosure or in the prior art more clearly, the following briefly introduces the attached figures required for describing the embodiments. Apparently, the attached figures in the following description show merely some embodiments of the present disclosure, and those skilled in the art may still derive other attached figures from these attached figures without creative efforts.

FIG. 1 is a schematic structural diagram of a drip irrigator for film-mulching drip irrigation; and

FIG. 2 is a top view of a film-mulching irrigation assembly.

List of reference characters: 1 ground; 2 annular pipeline; 3 connecting pipe; 4, branch pipe; 5 emitter; 6 main pipeline; 7 branch through pipe; 8 drip irrigator for film-mulching drip irrigation; 9 main through pipe; and 10 film.

### DETAILED DESCRIPTION OF THE EMBODIMENTS

The following clearly and completely describes the technical solutions in the embodiments of the present disclosure in combination with the attached figures in the embodiments of the present disclosure. Apparently, the described embodiments are merely some rather than all of the embodiments of the present disclosure. Based on the embodiment in the present disclosure, all other embodiments obtained by the ordinary technical staff in the art under the premise of without contributing creative labor belong to the scope protected by the present disclosure.

The present disclosure aims to provide a drip irrigator for film-mulching drip irrigation, a film-mulching irrigation assembly and an installation method of the film-mulching irrigation assembly, so as to achieve the purposes that water loss in soil is slowed down and emitters are prevented from being easily blocked.

To make the foregoing purpose, features and advantages of the present disclosure clearer and more comprehensible, the present disclosure is further described in detail below in combination with the attached figures and specific embodiments.

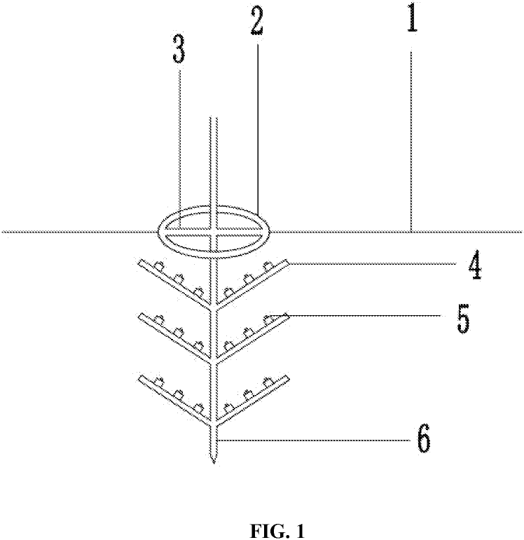

Referring to FIG. 1, a drip irrigator for film-mulching drip irrigation includes a main pipeline 6, an annular pipeline 2 and a plurality of branch pipes 4. One end of the main pipeline 6 is a closed end and an other end of the main pipeline 6 is an opening end. The annular pipeline 2 and the branch pipelines 4 are sequentially arranged on the main pipeline 6 from top to bottom and communicate with the main pipeline 6. Each branch pipe 4 is provided with a plurality of emitters 5, and the emitters 5 are arranged on an upper surface of the branch pipeline 4 and communicate with the branch pipe 4. Water outlet holes are formed in an inner ring wall and an outer ring wall of the annular pipeline 2, and the opening end of the main pipeline 6 communicates with a water conveying pipeline. The emitters 5 are arranged on the upper surface of each branch pipe 4, so that the emitters 5 can be effectively prevented from being blocked by wet soil. Meanwhile, the water outlet holes formed in the inner ring wall and the outer ring wall of the annular pipeline 2 can carry out drip irrigation to the ground 1 simultaneously, and the overall efficiency of the drip irrigation to the soil is guaranteed.

Referring to FIG. 1, a plane where the annular pipeline 2 is located is perpendicular to the main pipeline 6, and the main pipeline 6 is arranged in a center of the annular pipeline 2 and communicates with the annular pipeline 2 through a plurality of connecting pipes 3. That is to say, the annular pipeline 2 can be horizontally placed on the ground 1, wet drip irrigation to the ground 1 is completed through the water outlet holes of the annular pipeline, which guarantees that water in the annular pipeline 2 can irrigate the soil in a manner of the largest area and the fastest speed.

Further, the branch pipes 4 are distributed on the main pipeline 6 at equal intervals, and a distance between every two adjacent branch pipes 4 ranges from 4 cm to 6 cm.

Further, an included angle between each of the branch pipes 4 and the main pipeline 6 ranges from 30 degrees to 75 degrees, so that downward insertion of the main pipeline 6 and the branch pipes 4 is facilitated, and the resistance from the soil is reduced.

Referring to FIG. 1, the closed end of the main pipeline 6 is conical, so that it is guaranteed that the main pipeline 6 cannot deform when being inserted into the soil.

Further, the main pipeline 6 is made of polyethylene, so that the main pipeline 6 cannot deform when being inserted into soil.

Further, a distance between every adjacent two of emitters 5 is 0.2 cm to 0.5 cm, and a length of each of the branch pipes 4 is 2 cm to 5 cm.

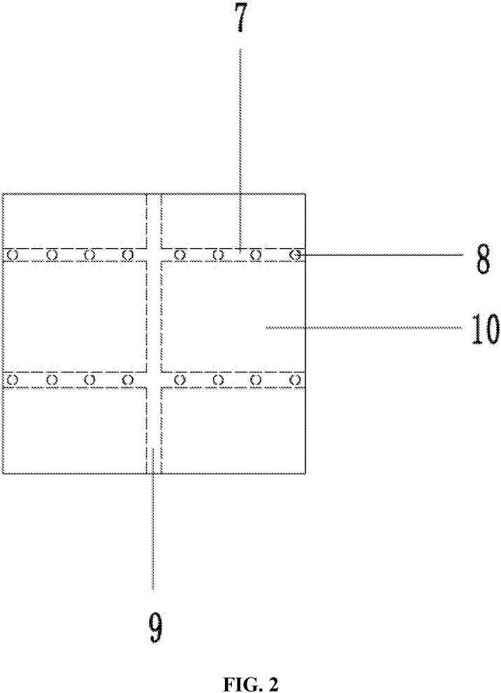

Referring to FIG. 2, a film-mulching irrigation assembly includes the drip irrigator for film-mulching drip irrigation, and further includes a main through pipe 9, a plurality of branch through pipes 7 and a film 10. The main through pipe 9 and the branch through pipes 10 are mulched with the film 10. The branch through pipes 7 are uniformly arranged on two sides of the main through pipe 9 respectively and communicate with the main through pipe 9. One end of the main through pipe 9 communicates with a micro-irrigation head pivot, and an other end of the main through pipe 9 is closed. An end, which is away from the main through pipe 9, of each of the branch through pipes 7 is closed, and the drip irrigators for film-mulching drip irrigation are arranged on a lower surface of each of the branch through pipes 7. In the film-mulching irrigation assembly, the main through pipe 9 and the branch through pipes 7 are mulched with the film 10, so the evaporation loss of water is reduced, sufficient water in the soil is guaranteed, and smooth growth of plants is guaranteed. Meanwhile, the waste of water for irrigation is avoided, and the purpose of saving water is achieved.

Referring to FIG. 2, the main through pipe 9 is perpendicular to each of the branch through pipes 7.

Further, a distance between every adjacent two of branch through pipes 7 arranged on the same side is 10 cm to 15 cm.

Referring to FIG. 2, an installation method of the film-mulching irrigation assembly includes the following steps. The film is arranged on the upper surfaces of the main through pipe 9 and a plurality of the branch through pipes 7 in advance. The drip irrigators for film-mulching drip irrigation are arranged on a lower surface of the branch through pipe 7. The film 10, the main through pipe 9 and the branch through pipes 7 which are arranged together are laid on the ground in advance. The drip irrigators for film-mulching drip irrigation are inserted under the ground. One end of the main through pipe 9 is connected with a micro-irrigation head pivot, and the other end thereof is closed. In this way, the installation of the film-mulching irrigation assembly is finally completed. The film 10 is arranged on the main through pipe 9 and the branch through pipes 7 in advance, so that the operation of an operator is simple and convenient in the installation process, and time and labor are saved. The construction efficiency is greatly improved, compared with the mode that the main through pipe 9 and the branch through pipes 7 are firstly laid and then the film 10 is laid.

Adaptive changes made according to actual requirements are all within the protection range of the present disclosure.

It needs to be noted that for those skilled in the art, apparently the present disclosure is not limited to the details of the exemplary embodiment, and the present disclosure can be achieved in other specific forms without departing from the spirit or essential characteristics of the present disclosure. Therefore, for every point, the embodiments should be regarded as exemplary embodiments and are unrestrictive. The scope of the present disclosure is defined by the claims appended hereto rather than the foregoing description. Therefore, all changes, including the meanings and scopes of equivalent elements, of the claims are aimed to be included in the present disclosure. Any reference signs in the claims should not be regarded as limitation to the involved claims.

What is claimed is:

1. A drip irrigator for film-mulching drip irrigation, comprising a main pipeline, as well as an annular pipeline and a plurality of branch pipes sequentially arranged on the main pipeline from top to bottom and communicate with the main pipeline, wherein an end of the main pipeline is closed end and an other end of the main pipeline is an opening end, each of the branch pipes is provided with a plurality of emitters, the emitters are arranged on an upper surface of the branch pipe and communicate with the branch pipe, water outlet holes are formed in an inner ring wall and an outer ring wall of the annular pipeline, and the opening end of the main pipeline communicates with a water conveying pipeline.

2. The drip irrigator for film-mulching drip irrigation according to claim 1, wherein a plane where the annular pipeline is located is perpendicular to the main pipeline, and the main pipeline is arranged in a center of the annular pipeline and communicates with the annular pipeline through a plurality of connecting pipes.

3. The drip irrigator for film-mulching drip irrigation according to claim 1, wherein the branch pipes are distributed on the main pipeline at equal intervals, and a distance between every adjacent two of the branch pipes ranges from 4 cm to 6 cm.

4. The drip irrigator for film-mulching drip irrigation according to claim 3, wherein an included angle between each of the branch pipes and the main pipeline ranges from 30 degrees to 75 degrees.

5. The drip irrigator for film-mulching drip irrigation according to claim 1, wherein the closed end of the main pipeline is conical.

6. The drip irrigator for film-mulching drip irrigation according to claim 5, wherein the main pipeline is made of polyethylene.

7. The drip irrigator for film-mulching drip irrigation according to claim 1, wherein a distance between every adjacent two of the emitters is 0.2 cm to 0.5 cm, and a length of each of the branch pipes is 2 cm to 5 cm.

8. A film-mulching irrigation assembly, comprising a drip irrigator for film-mulching drip irrigation, the drip irrigator for film-mulching drip irrigation comprising a main pipeline, as well as an annular pipeline and a plurality of branch pipes sequentially arranged on the main pipeline from top to bottom and communicate with the main pipeline, wherein an end of the main pipeline is closed end and an other end of the main pipeline is an opening end, each of the branch pipes is provided with a plurality of emitters, the emitters are arranged on an upper surface of the branch pipe and communicate with the branch pipe, water outlet holes are formed in an inner ring wall and an outer ring wall of the annular pipeline, and the opening end of the main pipeline communicates with a water conveying pipeline;
the film-mulching irrigation assembly comprises a main through pipe, a plurality of branch through pipes and a film, upper surfaces of the main through pipe and the branch through pipes are mulched with the film, the branch through pipes are uniformly arranged on two sides of the main through pipe respectively and communicate with the main through pipe, one end of the main through pipe communicates with a micro-irrigation head pivot, an other end of the main through pipe is closed; an end, which is away from the main through pipe, of each of the branch through pipes is closed, and the drip irrigator for film-mulching drip irrigation is arranged on a lower surface of each of the branch through pipes.

9. The film-mulching irrigation assembly according to claim 8, wherein the main through pipe is perpendicular to each of the branch through pipes.

10. An installation method of the film-mulching irrigation assembly, comprising:
arranging a film on upper surfaces of a main through pipe and a plurality of branch through pipes in advance, and arranging drip irrigators for film-mulching drip irrigation on a lower surface of each of the branch through pipes;
laying the film, the main through pipe and the branch through pipes which are arranged together in advance on a ground, and inserting the drip irrigators for film-mulching drip irrigation under the ground; and
connecting one end of the main through pipe with a micro-irrigation head pivot, and closing an other end of the main through pipe.

11. The film-mulching irrigation assembly according to claim 8, wherein a plane where the annular pipeline is located is perpendicular to the main pipeline, and the main pipeline is arranged in a center of the annular pipeline and communicates with the annular pipeline through a plurality of connecting pipes.

12. The film-mulching irrigation assembly according to claim 8, wherein the branch pipes are distributed on the main pipeline at equal intervals, and a distance between every adjacent two of the branch pipes ranges from 4 cm to 6 cm.

13. The film-mulching irrigation assembly according to claim 12, wherein an included angle between each of the branch pipes and the main pipeline ranges from 30 degrees to 75 degrees.

14. The film-mulching irrigation assembly according to claim 8, wherein the closed end of the main pipeline is conical.

15. The film-mulching irrigation assembly according to claim 14, wherein the main pipeline is made of polyethylene.

16. The film-mulching irrigation assembly according to claim 8, wherein a distance between every adjacent two of the emitters is 0.2 cm to 0.5 cm, and a length of each of the branch pipes is 2 cm to 5 cm.

17. The film-mulching irrigation assembly according to claim 11, wherein the main through pipe is perpendicular to each of the branch through pipes.

18. The film-mulching irrigation assembly according to claim 10, wherein the main through pipe is perpendicular to each of the branch through pipes.

19. The film-mulching irrigation assembly according to claim 12, wherein the main through pipe is perpendicular to each of the branch through pipes.

20. The film-mulching irrigation assembly according to claim 14, wherein the main through pipe is perpendicular to each of the branch through pipes.
